(19) United States
(12) Patent Application Publication
(10) Pub. No.: US 2005/0063380 A1
(43) Pub. Date: Mar. 24, 2005

(54) Initialization vector generation algorithm and hardware architecture

(76) Inventors: Mathew Kayalackakom, Cupertino, CA (US); Abhijit K. Choudhury, Cupertino, CA (US); Ken C.K. Chin, Saratoga, CA (US); Shekhar Ambe, San Jose, CA (US)

Correspondence Address: Pillsbury Winthrop LLP;Intellectual Property Group, Suite 200, 11682 El Camino Real, San Diego, CA, 92130-2092, US

(21) Appl. No.: 10/883,997

(22) Filed: Jul. 2, 2004

Related U.S. Application Data
(60) Provisional application No. 60/484,805, filed on Jul. 3, 2003.

(51) Int. Cl. H04L 12/56

(52) U.S. Cl. 370/389

(57) ABSTRACT

An apparatus provides an integrated single chip solution to solve a multitude of WLAN problems, and especially Switching/Bridging, and Security. In accordance with another aspect of the invention, the apparatus is able to terminate secured tunneled 802.11i, IPSec and L2TP with IPSec traffic. In accordance with a further aspect of the invention, the apparatus is also able to handle computation-intensive security-based algorithms including per packet Initialization Vector generation without significant reduction in traffic throughput. The architecture is such that it not only resolves the problems pertinent to WLAN it is also scalable and useful for building a number of useful networking products that fulfill enterprise security and all possible combinations of wired and wireless networking needs.

### CROSS-REFERENCE TO RELATED APPLICATIONS

The present application claims priority to provisional application 60/484,805, filed on Jul. 3, 2003.

### FIELD OF THE INVENTION

Aspects of the present invention relate generally to network communications, and more particularly, to wired and wireless networks and architectures.

### BACKGROUND

The Wireless Local Area Network (WLAN) market has recently experienced rapid growth, primarily driven by consumer demand for home networking. The next phase of the growth will likely come from the commercial segment comprising enterprises, service provider networks in public places (Hotspots), multi-tenant, multi-dwelling units (MxUs) and small office home office (SOHOs). The worldwide market for the commercial segment is expected to grow from 5M units in 2001 to over 33M units in 2006. However, this growth can be realized only if the issues of security, service quality and user experience are addressed effectively in newer products.

FIG. 1 illustrates possible wireless network topologies. As shown in FIG. 1, a wireless network 100 typically includes at least one access point 102, to which wireless-capable devices such as desktop computers, laptop computers, PDAs, and cell phones can connect via wireless protocols such as 802.11a/b/g. Several or more access points 102 can be further connected to an access point controller 104. Switch 106 can be connected to multiple access points 102, access point controllers 104, or other wired and/or wireless network elements such as switches, bridges, computers, servers, etc. Switch 106 can further provide an uplink to another network. Many possible alternative topologies are possible, and this figure is intended to illuminate, rather than limit, the present inventions.

Problems with security, in particular, are relevant to all possible deployments of wireless networks. Most of the security problems have been brought on by flaws in the WEP algorithm which seriously undermine the security of the system making it unacceptable as an Enterprise solution. In particular, current wireless networks are vulnerable to:
Passive attacks to decrypt traffic based on statistical analysis.

Active attack to inject new traffic from unauthorized mobile stations, based on known plaintext.
Active attacks to decrypt traffic, based on tricking the access point.
Dictionary-building attacks that, after analysis of about a day's worth of traffic, allows real-time automated decryption of all traffic.

Analysis suggests that all of these attacks can be mounted using only inexpensive off-the-shelf equipment. Anyone using an 802.11 wireless network should not therefore rely on WEP for security, and employ other security measures to protect their wireless network. In addition WLAN also has security problems that are not WEP related, such as:
Easy Access—“War drivers” have used high-gain antennas and software to log the appearance of Beacon frames and associate them with a geographic location using GPS. Short of moving into heavily shielded office space that does not allow RF signals to escape, there is no solution for this problem.
“Rogue” Access Points—Easy access to wireless LANs is coupled with easy deployment. When combined, these two characteristics can cause headaches for network administrators. Any user can run to a nearby computer store, purchase an access point, and connect it to the corporate network without authorization an thus be able to roll out their own wireless LANs without authorization.
Unauthorized Use of Service—For corporate users extending wired networks, access to wireless networks must be as tightly controlled as for the existing wired network. Strong authentication is a must before access is granted to the network.
Service and Performance Constraints—Wireless LANs have limited transmission capacity. Networks based on 802.11b have a bit rate of 111 Mbps, and networks based on the newer 802.11a technology have bit rates up to 54 Mbps. This capacity is shared between all the users associated with an access point. Due to MAC-layer overhead, the actual effective throughput tops out at roughly half of the nominal bit rate. It is not hard to imagine how local area applications might overwhelm such limited capacity, or how an attacker might launch a denial of service attack on the limited resources.
MAC Spoofing and Session Hijacking—802.11 networks do not authenticate frames. Every frame has a source address, but there is no guarantee that the station sending the frame actually put the frame “in the air.” Just as on traditional Ethernet networks, there is no protection against forgery of frame source addresses. Attackers can use spoofed frames to redirect traffic and corrupt ARP tables. At a much simpler level, attackers can observe the MAC addresses of stations in use on the network and adopt those addresses for malicious transmissions.
Traffic Analysis and Eavesdropping—802.11 provides no protection against attackers that passively observe traffic. The main risk is that 802.11 does not secure data in transit to prevent eavesdropping. Frame headers are always “in the clear” and are visible to anybody with a wireless network analyzer.

There are no enterprise-class wireless network management systems that can address all of these problems. Attempts have been made to address certain of these problems, usually on a software level.

Meanwhile, however, many WLAN vendors are integrating combined 802.11 a/g/b standards into their chipsets. Such chipsets are targeted for what are called Combo-Access Points which will allow users associated with the Access Points to share 100 Mbits of bandwidth in Normal Mode and up to ˜300 Mbits in Turbo Mode. The table below shows why a software security solution without hardware acceleration is not feasible when bandwidth/speeds exceed 100 Mbits.

| | | Required | | |
|---|---|---|---|---|
| | | Processor Speed | | |
| Interface | | [MHz] | | CPU |
| | BW | | IPSec + | Subsys |
| Type | [Mbs] | IPSec | Other | Cost |
| DSL | 1-5 | 133 | 200+ | |
| Ether | 10 | 300 | 500+ | |
| 802.11a | 30-50 | 1200 | 1500+ | $400 |
| | | | | [2002] |
| | | | | $125 |
| | | | | [2004] |
| Fast | 100 | 2500 | 3000+ | $600 |
| Ether | | | | [2002] |
| | | | | $250 |
| | | | | [2004] |

| | | |
|---|---|---|
| Multiple | 500 | Not Feasible in Software |
| FE | | Needs Dedicated Hardware |
| Gigabit | 1000 | |
| Ether | | |

Current solutions also provide only limited support for switching of IPSec and L2TP with IPSec traffic. Moreover, many encryption modes require per packet Initialization Vector (Initialization Vector) generation which can involve very complex and computation-intensive algorithms to ensure secrecy, but which can substantially reduce traffic throughput if not handled efficiently.

Some cipher modes, including the CBC mode which IPsec uses, require some extra data at the beginning. This data is called the Initialization vector. It need not be secret, but should be different for each message. Its function is to prevent messages which begin with the same text from encrypting to the same ciphertext. That might give an analyst an opening, so it is best prevented.

Although infrastructures for wired networks have been highly developed, the above and other problems of wireless networks are comparatively less addressed. Meanwhile, there is a need to address situations where enterprises and/or networks may have any combination of both wired and wireless components.

### SUMMARY

Aspects of the present invention relate generally to a single-chip solution that addresses current weaknesses in wireless networks, but yet is scalable for a multitude of possible wired and/or wireless implementations. Current solutions to resolve/overcome the weaknesses of WLAN are only available in the form of Software or System. These resolve only specific WLAN problems and they don't address all of the existing limitations of wireless networks.

In accordance with an aspect of the invention, an apparatus provides an integrated single chip solution to solve a multitude of WLAN problems, and especially Switching/Bridging, and Security. In accordance with another aspect of the invention, the apparatus is able to terminate secured tunneled IPSec L2TP with IPSec, PPTP, SSL, 802.11i traffic. In accordance with a further aspect of the invention, the apparatus is also able to handle computation-intensive security-based algorithms including per packet Initialization Vector generation without significant reduction in traffic throughput. The architecture is such that it not only resolves the problems pertinent to WLAN it is also scalable and useful for building a number of useful networking products that fulfill enterprise security and all possible combinations of wired and wireless networking needs.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates wireless network topologies;

FIG. 2 is a block diagram illustrating a wired and wireless network device architecture in accordance with the present invention; and

FIG. 3 is a block diagram illustrating a crypto engine with hardware support for per packet Initialization Vector generation in accordance with the present invention.

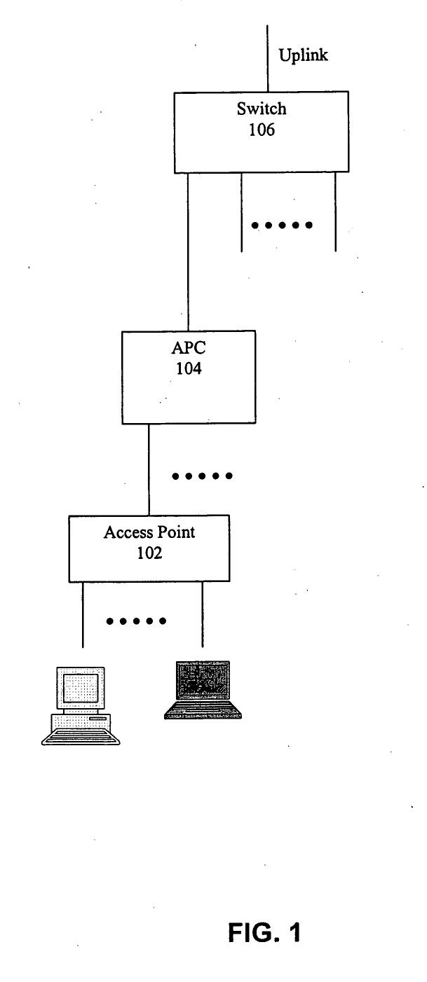

### DETAILED DESCRIPTION

One aspect of the present invention is to deliver a single chip solution to solve wired and wireless LAN Security, including the ability to terminate a secure tunnel in accordance with such protocols as IPSec and L2TP with IPSec, 802.11i including the efficiently ability to handle per packet Initialization Vector generation without a reduction in throughput. Such a single chip solution may be scalable to enable implementation in the various components and alternative topologies of wired and/or wireless networks, such as, for example, in an access point, an access point controller, or in a switch.

The embodiments of the present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Still further, the present invention encompasses present and future known equivalents to the known components referred to herein by way of illustration, and implementations including such equivalents are to be considered alternative embodiments of the invention.

The attached Appendix forms part of the present disclosure and is incorporated herein by reference.

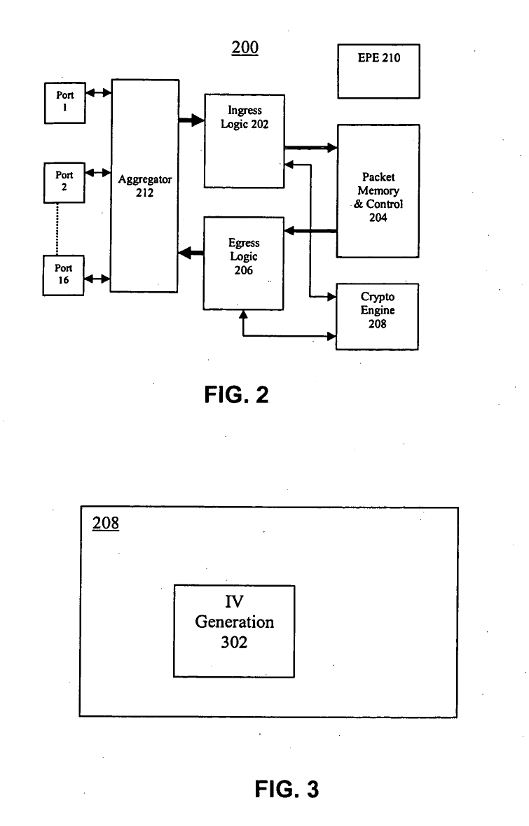

FIG. 2 is a block diagram illustrating an example implementation of a single-chip wired and wireless network device 200 that can be used to implement the features of the present invention. As shown in FIG. 2, chip 200 includes ingress logic 202, packet memory and control 204, egress logic 206, crypto engine 208, an embedded processor engine 210 and an aggregator 212. One example device 200 is described in detail in co-pending application Ser. No. ______ (Atty. Dkt. 79202-309844 (SNT-001)), the contents of which are incorporated herein by reference.

In accordance with one aspect of the invention, IPSec packets received and destined for the chip 200 are forwarded to the Crypto Engine 208 for authentication and decryption. Normally a VPN Session between WLAN Client and Access Point/Switch uses the IPSec tunnel mode (transport mode can be used for network management). The Pre-parsing is done by the Ingress logic to determine the type of packet, whether it is IKE, IPSec, L2TP, PPTP, or 802.11i.

As described in more detail in co-pending application Ser. No. ______ (Atty. Dkt. 79202-304634 (SNT-004)), incorporated herein by reference, the Crypto Engine is able to provide hardware acceleration for IKE VPN authentication, encryption and decryption for packets destined to and tunneled packets from a WLAN network. Of the standards for authentication, encryption and decryption device 200 will support those for 802.11i, SSL, TLS, IPSec, PPTP with MPPE and L2TP with IPSec. All packets originating from and destined to WLAN clients are tunneled using 802.11i, IPSec VPN, L2TP, PPTP or SSL. The authentication, encryption and decryption method used for tunneling is configurable and negotiated between a device 200-based peer and the WLAN client. As per tunneling standards a single policy or a policy bundle may govern packet authentication, encryption/decryption.

In accordance with an aspect of the present invention, crypto engine 208 further includes hardware acceleration for per packet Initialization Vector generation.

Per packet Initialization Vector generation may be implemented for all packets encrypted and meant for transmission via one of the ports. Packets using WEP, WEP+TKIP, DES-CBC and AES encryption modes require per packet Initialization Vector. Meanwhile, Initialization Vector Generation should perform at line rate to ensure egress 802.11i, IPSec processing does not stall packet processing.

Ideally an Initialization Vector is a secret and unique number, separated from other Initialization Vector's by high-hamming distance. An Initialization Vector is supposed to be a nonce and a failure in this assumption would create a security hole. The secret Initialization Vector is guaranteed to be unique if it is derived from unique numbers by a collision-free function. Hamming distance between secret IVs, summarized in RFC2405.6, explains that low hamming distance between IVs may ease cryptanalysis attacks (e.g. differential ones). Secret Initialization Vector avoids this flaw because a block cipher is assumed to be a pseudo-random permutation i.e. the ciphertext cannot be linked to its plaintext by those who do not have the key. Thus the Initialization Vector looks random for an attacker and the hamming distance between IVs is high, even if the Initialization Vector is derived from a low-Hamming distance source.

The SPI and ESP sequence numbers (RFC2406.2.2) are ensured to be unique during the lifetime of a key assuming the anti-replay protection is enabled. Moreover the derivation function is a block cipher which prevents collision by guaranteeing that any plaintext has a unique ciphertext. Secrecy of the Initialization Vector—The secrecy of the Initialization Vector is useful against attacks that require predictable Initialization Vector. In this case, it makes a differential cryptanalysis based on the Initialization Vector significantly harder. An attacker can try to obtain the Initialization Vector by knowing the ESP sequence number that generated it or by deriving it from the first block of ciphertext:
1. The attacker is unable to generate the Initialization Vector based on the ESP sequence number without the knowledge of the secret key or the ability to break the block cipher algorithm.
2. With CBC, OFB and CFB, the Initialization Vector is encrypted before being included in the ciphertext so the attacker is unable to deduce it.
   Thus the secret Initialization Vector generated by block 302 is guaranteed to be secret if the attacker is unable to break the cipher algorithm. This is provided by the crypto engine of the present invention, which enables unique number generation with adequate Hamming distance, as shown in FIG. 3.

Although the present invention has been particularly described with reference to the embodiments herein, it should be readily apparent to those of ordinary skill in the art that changes and modifications in the form and details may be made without departing from the spirit and scope of the invention. It is intended that the appended claims include such changes and modifications.

1. An apparatus for application in a wired and/or wireless network comprising:
an ingress path and an egress path that are scalable for a variety of implementations for the apparatus;
an aggregator that receives packets from ports and provides a stream for the ingress path, and that receives a stream from the egress path and outputs packet data to the ports; and
a crypto engine including a hardware accelerator for per packet secret Initialization Vector generation.

2. An apparatus for application in a wired and/or wireless network comprising:
a scalable ingress path;
a scalable egress path;
an aggregator configured to receive packets from ports, configured to provide a stream for the ingress path, configured to receive a stream from the egress path, and configured to output packet data to the ports;
an encryptor block configured to generate an Initialization vector, and configured to encrypt each packet in the stream from the egress path with the secret Initialization vector.

3. The apparatus of claim 2, wherein the Initialization vector is generate using a collision-free function.

4. The apparatus of claim 3, wherein the encryptor block is further configured to use WEP, WEP+TKIP, DES-CBC, or AES encryption.

5. The apparatus of claim 3, wherein the scalable ingress path is further configured to determine whether the stream for the ingress path has to undergo decryption.

6. The apparatus of claim 4, wherein the scalable ingress path is further configured to determine whether the stream for the ingress path has to undergo authentication.

7. The apparatus of claim 5, further comprises:
a packet memory configured to store data from the stream for the ingress path and to the data stream for the egress path.

8. The apparatus of claim 7, further comprises:
a packet memory scheduler configured to schedule the data from the packet memory to the data stream for the egress path.

9. The apparatus of claim 8, wherein the scalable egress path is further configured to determine whether the stream for the egress path has to undergo encryption.

10. The apparatus of claim 9, wherein the scalable egress path is further configured to request that the encryptor block encrypt the stream for the egress path.

11. The apparatus of claim 11, wherein the decryptor block or the encryptor block supports Encryption algorithms.

12. The apparatus of claim 11, wherein the decryptor block or the encryptor block supports Authentication algorithms.

13. The apparatus of claim 10, wherein the egress path further comprises:
access control logic configured to limit apparatus access to an access control list.

14. The apparatus of claim 13, wherein the access control list is part of a user profile.

15. The apparatus of claim 13, wherein the access control list is used to assign a priority of the packet received from the ports.

16. An method of processing data packets in a wired and/or wireless network comprising:
receiving a packet stream from one or more ports;
providing the packet stream to a scalable ingress path;
storing the packet stream;
outputting the packet stream to the one or more ports via a scalable egress path;
generating an Initialization vector;
encrypting each packet in the stream from the egress path with the secret Initialization vector.

17. The method of claim 16, wherein the Initialization vector is generated using a collision-free function.

18. The method of claim 17, wherein the encrypting each packet uses WEP, WEP+TKIP, DES-CBC, or AES encryption.

19. The method of claim 18 further comprising:
determining whether the packet stream received from one or more ports has to undergo authentication.

20. The method of claim 19 further comprising:
authenticating the packet stream received from one or more ports when the packet stream requires authentication.

21. The method of claim 20, further comprises:
scheduling the output of the packet stream to the one or more ports via a scalable egress path.

22. The method of claim 21, further comprises:
determining whether the packet stream in the scalable egress path has to undergo encryption.

23. The method of claim 22 further comprising:
encrypting the packet stream when the packet stream in the scalable egress path has to undergo encryption.

24. The method of claim 23, wherein the encryption is an 802.11i, IPSec, L2TP with IPSec, PPTP, or SSL Encryption algorithm.

25. The method of claim 24, wherein the authentication is an 802.11i, IPSec, L2TP with IPSec, PPTP, or SSL Authentication algorithm.

26. The method of claim 23, further comprises:
limiting access to an access control list.

27. The method of claim 26, wherein the access control list is part of a user profile.

28. The method of claim 26, wherein the access control list is used to assign a priority of the packet stream received from the ports.

29. A computer-readable medium, encoded with data and instructions, such that when executed by a computer, the instructions causes the computer to:
receive a packet stream from one or more ports;
provide the packet stream to a scalable ingress path;
store the packet stream;
output the packet stream to the one or more ports via a scalable egress path;
generate an Initialization vector;
encrypt each packet in the stream from the egress path with the secret Initialization vector.

30. The computer-readable medium of claim 29, wherein the Initialization vector is generated using a collision-free function.

31. The computer-readable medium of claim 30, wherein the encryption is further DES-CBC, WEP, WEP+TKIP or AES encryption.

32. The computer-readable medium of claim 31 further comprising instructions to:
determine whether the packet stream received from one or more ports has to undergo authentication.

33. The computer-readable medium of claim 32 further comprising instructions to:
authenticate the packet stream received from one or more ports when the packet stream requires authentication.

34. The computer-readable medium of claim 33, further comprises instructions to:
schedule the output of the packet stream to the one or more ports via a scalable egress path.

35. The computer-readable medium of claim 34, further comprise instructions to s:
determine whether the packet stream in the scalable egress path has to undergo encryption.

36. The computer-readable medium of claim 35 further comprising instructions to:
encrypt the packet stream when the packet stream in the scalable egress path has to undergo encryption.

37. The computer-readable medium of claim 36, wherein the encryption is an IPSec, L2TP with IPSec, PPTP, or SSL Encryption algorithm.

38. The computer-readable medium of claim 37, wherein the authentication is an IPSec, L2TP with IPSec, PPTP, or SSL Authentication algorithm.

39. The computer-readable medium of claim 36, further comprising instructions to:
limit access to an access control list.

40. The computer-readable medium of claim C39, wherein the access control list is part of a user profile.

41. The computer-readable medium of claim 39, wherein the access control list is used to assign a priority of the packet stream received from the ports.

42. An apparatus of processing data packets in a wired and/or wireless network comprising:
means for receiving a packet stream from one or more ports;
means for providing the packet stream to a scalable ingress path;
means for storing the packet stream;
means for outputting the packet stream to the one or more ports via a scalable egress path;
means for generating an Initialization vector;
means for encrypting each packet in the stream from the egress path with the secret Initialization vector.

43. The apparatus of claim 42, wherein the Initialization vector is generated using a collision-free function.

44. The apparatus of claim 43, wherein the means for encrypting is further configured to use DES-CBC, WEP, WEP+TKIP or AES encryption.

45. The apparatus of claim 44 further comprising:
means for determining whether the packet stream received from one or more ports has to undergo authentication.

46. The apparatus of claim 45 further comprising:
means for authenticating the packet stream received from one or more ports when the packet stream requires authentication.

47. The apparatus of claim 45, further comprises:
means for scheduling the output of the packet stream to the one or more ports via a scalable egress path.

48. The apparatus of claim 47, further comprises:
means for determining whether the packet stream in the scalable egress path has to undergo encryption.

49. The apparatus of claim 48 further comprising:
means for encrypting the packet stream when the packet stream in the scalable egress path has to undergo encryption.

50. The apparatus of claim 49, wherein the encryption as per 802.11i, IPSec, L2TP with IPSec, PPTP, or SSL Encryption algorithm.

51. The apparatus of claim 50, wherein the authentication as per 802.11i, IPSec, L2TP with IPSec, PPTP, or SSL Authentication algorithm.

52. The apparatus of claim 49, further comprises:
means for limiting access to an access control list.

53. The apparatus of claim 52, wherein the access control list is part of a user profile.

54. The apparatus of claim 52, wherein the access control list is used to assign a priority of the packet stream received from the ports.
